(19) United States
(12) Patent Application Publication
(10) Pub. No.: US 2018/0313981 A1
(43) Pub. Date: Nov. 1, 2018

(54) VIRTUAL AND AUGMENTED REALITY DEVICES WITH STRUCTURED SURFACES

(71) Applicant: Corning Incorporated, Corning, NY (US)

(72) Inventors: Joshua Monroe Cobb, Victor, NY (US); Mark Francis Krol, Painted Post, NY (US)

(21) Appl. No.: 15/960,932

(22) Filed: Apr. 24, 2018

Related U.S. Application Data
(60) Provisional application No. 62/491,783, filed on Apr. 28, 2017.
(60) Provisional application No. 62/525,391, filed on Jun. 27, 2017.

(51) Int. Cl. G02B 1/118; G02B 5/18; G02B 27/48

(52) U.S. Cl. CPC G02B 1/118; G02B 2207/101; G02B 27/48; G02B 5/18

(57) ABSTRACT

A virtual or an augmented reality device comprising: (i) a display component comprising a display surface, (ii) a lens air spaced from the display component; wherein at least one of the display component or the lens comprises a stray light reducing nanostructured surface.

This application claims the benefit of priority under 35 U.S.C § 119 of U.S. Provisional Application Ser. No. 62/491,783, filed on Apr. 28, 2017 and 62/525,391, filed on Jun. 27, 2017 the contents of which are relied upon and incorporated herein by reference in their entirety.

### BACKGROUND

The disclosure relates generally to virtual reality devices and augmented reality devices that have structured surfaces, and more specifically to head wearable devices with structured surfaces for stray light control.

Virtual reality (VR) and augmented reality headsets create an immersive visual experience for the viewer. However, because these devices comprise multiple air spaced optical components unwanted stray light may reflect from one or more surface of these components, and propagate towards viewer's eyes, degrading the image presented to the viewer.

No admission is made that any reference cited herein constitutes prior art. Applicant expressly reserves the right to challenge the accuracy and pertinence of any cited documents.

### SUMMARY

One embodiment of the disclosure relates to a virtual or an augmented reality device comprising:
(i) a display component comprising a display surface,
(ii) a lens air spaced from the display component; wherein

at least one of said display component or said lens comprises a stray light reducing structured surface.

According to some embodiments the stray light reducing structured surface comprises a plurality of nanostructures. According to some embodiments the plurality of nanostructures have widths greater than 1 nm and less than 1 micron.

According to some embodiments the virtual or augmented reality device comprises a plurality of stray light reducing structured surfaces. According to some embodiments both the lens and the display component comprise at least one a stray light reducing structured surface comprising a plurality of nanostructures.

According to some embodiments, the lens has at least one curved refractive surface. According to some embodiments the refractive surface may be either convex or concave. According to some embodiments, the virtual or augmented reality device comprises at least one reflective surface. According to some embodiments, the device comprises at least one curved reflective surface.

According to some embodiments of the device the display component is situated so as to be substantially perpendicular to a line of sight of a viewer. According to some embodiments of the device, the display component and the lens are situated so as to be substantially perpendicular to a line of sight of a viewer. According to some embodiments of the device principal axis of the lens is substantially normal to viewer's line of sight. According to some embodiments of the device, the lens and the display component are situated so to intercept viewer's line of sight. According to other embodiments of the device, the lens and the display component are situated so as to not intercept viewer's line of sight.

According to some embodiments of the virtual or augmented reality devices, the stray light reducing structured surface comprises a coating. According to some embodiments of the virtual or augmented reality devices, the stray light reducing structured surface comprises a structured coating. According to some embodiments of the virtual or augmented reality devices, the stray light reducing structured surface comprises a nanostructured coating.

According to some embodiments of the virtual reality or augmented reality devices, the stray light reducing structured surface is an anti-reflective surface.

According to some embodiments the display component comprises a display surface and a diffraction element, and the diffraction element is being situated between the display surface and the stray light reducing structured surface. According to some embodiments the stray light reducing structured surface of the display component is a structured anti-reflective coating. According to some embodiments the anti-reflective coating comprises a plurality of nanostructures.

According to some embodiments of the virtual or augmented reality devices, the stray light reducing structured surface of the display component comprises: (a) a structured anti-reflective coating or a structured anti-reflective surface; and (b) diffraction element, wherein the diffraction element is situated either (i) between the display surface and the structured anti-reflective coating; and/or (ii) between the display surface and the structured anti-reflective surface.

An additional embodiment of the disclosure relates to an augmented reality device comprising:
(i) a display component comprising a display surface,
(ii) at least one lens comprising a concave refractive surface, said at least one lens being spaced from the display component; wherein
   at least one of said display component or said lens comprises at least one stray light reducing structured surface. According to some embodiments the augmented reality device comprises two lens components. According to some embodiments the augmented reality device comprises at list one lens component and a mirror. According to some embodiments the at least one stray light reducing structured surface comprises a plurality of nanostructures, the plurality of nanostructures having widths greater than 1 nm and less than 1 micron.

An additional embodiment of the disclosure relates to an augmented reality device comprising:
(i) a display component comprising a display surface,
(ii) a lens comprising a concave refractive surface, said lens being air spaced from the display component; wherein
at least one of said display component or said lens comprises at least one stray light reducing structured surface.

According to some embodiments stray light reducing structured surface of the augmented reality device is a structured anti-reflective surface and/or a structured anti-reflective coating. According to some embodiments of the augmented reality device the lens is a meniscus lens. According to some embodiments the display surface is not perpendicular to a line of sight of a viewer.

According to some embodiments the at least one lens is spaced apart from the display component and has an incident refractive surface concave to the display surface and a reflective surface that is also concave to the display surface, wherein a principal axis of the reflective surface is normal to the display surface; and a beam splitter plate is disposed in free space between the display surface and the lens, the beam splitter plate and having first and second parallel surfaces that are oblique to a line of sight of a viewer.

According to some embodiments the display component comprises the stray light reducing structured surface comprises a diffraction element situated between the display surface and the stray light reducing structured surface. According to some embodiments stray light reducing structured surface comprises a structured anti-reflective coating or a structured anti-reflective surface. According to some embodiments the stray light reducing structured surface comprises a plurality of nano structures.

According to some embodiments stray light reducing structured surface of the display component comprises: a structured anti-reflective coating or a structured anti-reflective surface; and the display component further comprises a diffraction element situated between the display surface and the structured anti-reflective coating or the structured anti-reflective surface.

According to some embodiments of the augmented reality or virtual reality devices, the display component further comprises a transparent substrate comprising an anti-reflective surface and a diffraction element disposed below the anti-reflective surface, wherein the transparent substrate, when disposed in front of a pixelated display of the display surface at least partially reduces inter-pixel gaps in the pixelated display

Additional features and advantages will be set forth in the detailed description which follows, and in part will be readily apparent to those skilled in the art from the description or recognized by practicing the embodiments as described in the written description and claims hereof, as well as the appended drawings.

It is to be understood that both the foregoing general description and the following detailed description are merely exemplary, and are intended to provide an overview or framework to understand the nature and character of the claims.

The accompanying drawings are included to provide a further understanding, and are incorporated in and constitute a part of this specification. The drawings illustrate one or more embodiment(s), and together with the description serve to explain principles and operation of the various embodiments.

### BRIEF DESCRIPTION OF THE DRAWINGS

FIG. 1A is a schematic cross-sectional view of a virtual reality device;

FIG. 1B illustrate schematically stray light propagation in the virtual reality device of FIG. 1A;

FIG. 2A is a schematic cross-sectional view of one embodiment of the virtual reality device;

FIG. 2B illustrates stray light propagation in the virtual reality device of FIG. 2A;

FIG. 3A illustrates an exemplary anti-reflective structured coating surface according to one or more embodiment described herein;

FIGS. 3B-3E illustrate other embodiments of exemplary anti-reflective structured coating surfaces described herein;

FIG. 4 is a schematic cross-sectional view of another embodiment of the virtual reality device;

FIG. 5 is a schematic representation of a pixel comprising rectangular red (R), green (G), and blue (B) sub-pixels;

FIG. 6 is a cross-sectional schematic view of a display component comprising a transparent substrate and a pixelated display; and

FIG. 7 is a schematic cross-sectional view of an embodiment of the augmented reality device.

### DETAILED DESCRIPTION

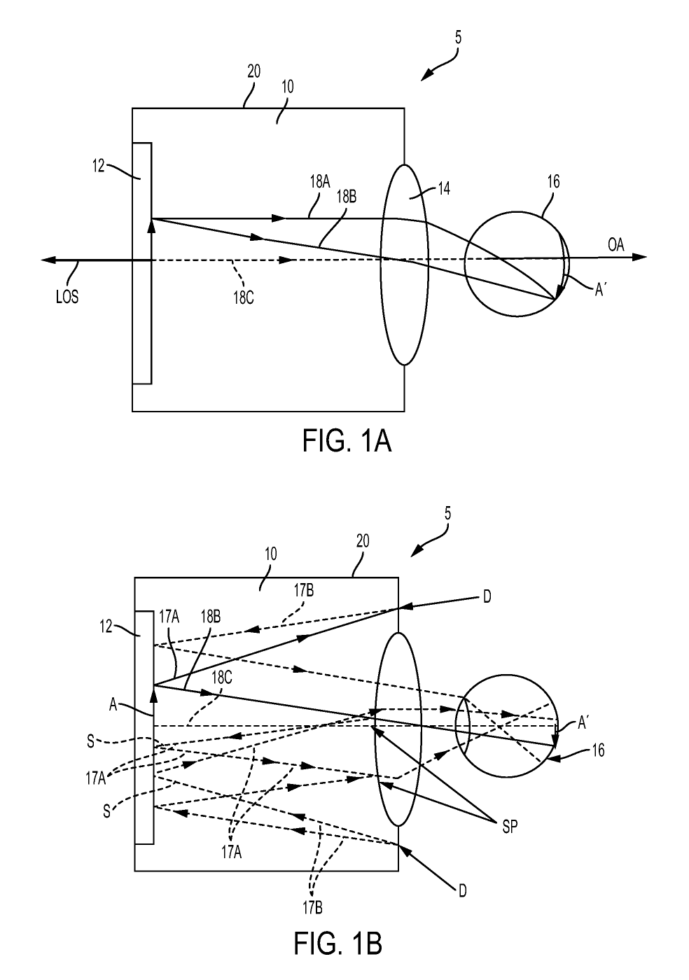

FIG. 1A is a schematic cross-sectional view of a virtual reality device. The optical system 10 of the reality device 5 shown in FIG. 1A comprises a display component 12 that displays a scene A (object) that will be viewed by the viewer, and at least one lens 14 situated between the display component 12 and the viewer's eye 16. The display component and the at least one lens 16 are supported by an enclosure 20. More optical components may be optionally present within the enclosure 20. For example, in some embodiments, the display component 12 may comprise a liquid crystal display (LCD), an OLED display. Other display components 12 may also be utilized.

FIG. 1A illustrates an optical path of three light rays 18A, 18B, and 18C that form an image A′ of the object A on the viewer's retina. As shown in FIG. 1A, the rays 18A and 18B originate from a single object point are traced through the optical system formed by the optical components of the optical system 10 of the virtual reality VR device 5. Ray 18C originates from a different object point and is propagating along the optical axis OA.

FIG. 1B illustrates stray light propagation in the optical system of the virtual reality device shown in FIG. 1A. More specifically, FIG. 1B illustrates specular stray light rays propagating towards the eye(s) of the viewer. The specular stray light rays shown (rays 17A) originate or are generated by reflections from optical quality surfaces and obey the law of reflection at an optical interface, i.e. θ_{incident}=−θ_{reflected}. When stray light rays 17A may propagate toward the eye(s), they are imaged on the retina, interfering with the image quality of the image A′. FIG. 1B also illustrates diffuse stray rays (rays 17B) that are generated by reflections from diffusely scattering surfaces D, for example surfaces designed to reduce stray light. In the latter case, the incident rays are scattered into a solid angle of possible reflected rays. For illustrative purposes FIG. 1B shows only a single (diffuse) stray light ray originated from each diffuse reflection position. However, multiple stray light rays due to diffuse reflection are actually produced from a single point of incidence (not shown). Stray light rays 17B reflect from (or refract through) the optical surfaces of the optical components (e.g., display surface or lens surfaces) and propagate toward the eye(s), interfering with the overall image quality of the device.

The resulting effect of stray light in the optical system is a severely degraded image quality in the form of image distortion, scatter, and reduced contrast. Hard optical anti-reflection coatings can be applied to the surfaces of the lens(es) and on the display surface via physical vapor or chemical vapor deposition techniques, to minimize stray light propagation. However, these techniques are technically complex and do not easily scale to the high volumes required for consumer electronics products, and hence are typically too costly.

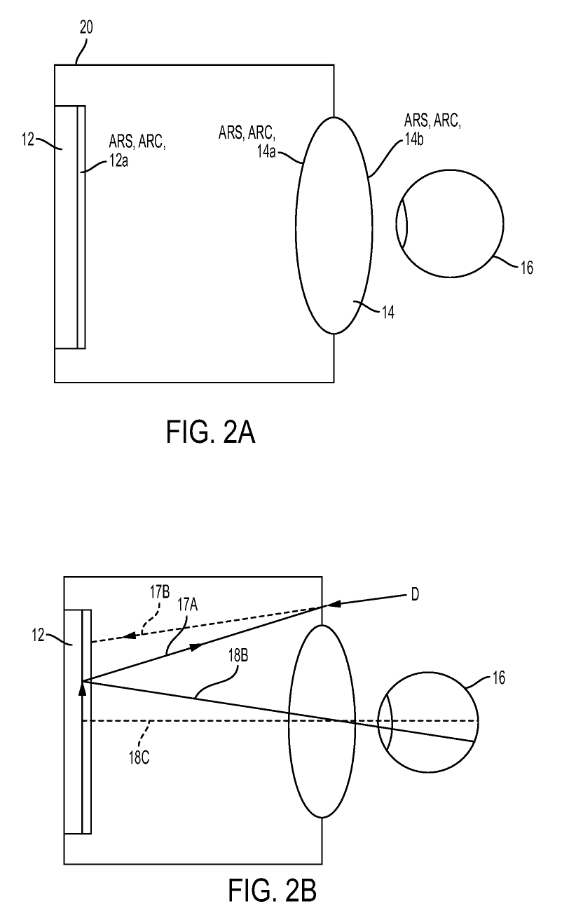

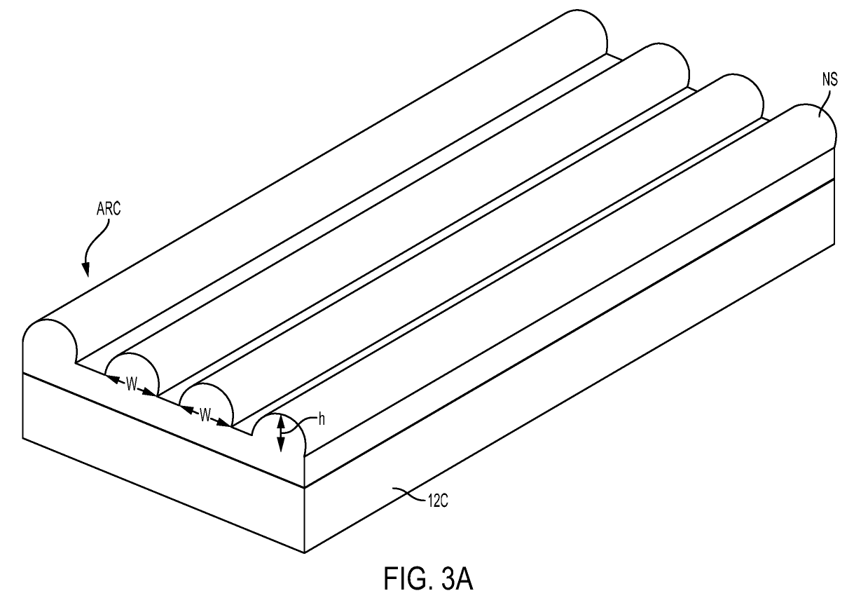

The embodiments described herein utilize nanostructured optical surfaces to reduce and eliminate or minimize stray light and the resulting image degradation observed by the viewer using VR or AR devices. As used herein, a nanostructured surface or coating comprise a structured surface with a plurality of nano-sized structures NS having height and width greater than 1 nm and less than 1 micron (e.g., 3 nm to 500 nm, 10 nm to 500 nm, 10 nm to 400 nm, or 50 nm to 350 nm). FIG. 2A illustrates an optical system 10 with stray light reducing structured surfaces—for example nanostructured anti-reflective surfaces or coatings (ARS, ARC) situated on the surfaces of the optical components. According to some embodiments, the surfaces of the optical components comprise light reducing structured surfaces, for example nanostructured anti-reflective surfaces ARS that may be formed integrally therein. More specifically, FIG. 2A illustrates, for example, anti-reflective nanostructured coatings 14a, 14b and 12a that are applied to the two optical surfaces of the lens 14 and on the front surface (display surface) of the display component 12. In some embodiments of the AR or VR devices the optical system 10 utilizes additional optical components (e.g., mirrors, plates, beam splitters, polarizers, or other lens components), and these additional components may also include one or more anti-reflective nanostructured surfaces or coatings. These additional optical components may be situated between the display component and the viewer, for example between the display component 12 and the lens 14. The nanostructured optical surfaces may be, for example, nanostructured anti-reflective coatings (ARC), or anti-reflective nanostructured surface (ARs) formed directly on the surface of the optical component.

FIG. 2B illustrates stray light rays propagating within the optical system 10 shown in FIG. 2A. As shown in FIG. 2B, the use of nanostructured anti-reflective coatings or surfaces (ARC, ARS) such as 12a, 14a, and/or 14b dramatically reduces the impact of stray light generated by diffuse reflections in the optical system and also minimizes or eliminates stray light due to specular reflections. These nanostructured coatings or surfaces can reduce reflection across the visible spectrum (450 nm-700 nm or at the specific wavelength(s) of interest (e.g., UV, red, blue, or green wavelengths). This improves the quality of the image presented to the eye of the observer.

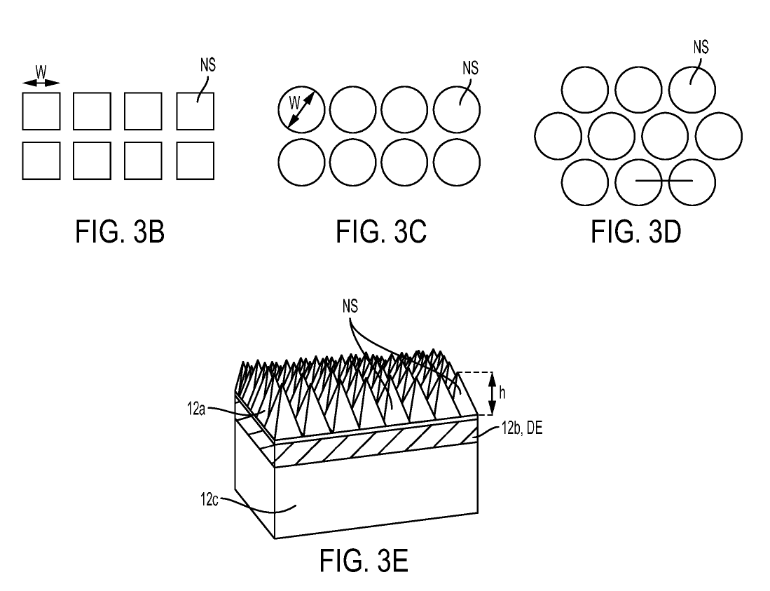

Exemplary anti-reflective nanostructured anti-reflective surfaces or coatings (ARS, ARC) are illustrated, for example, in FIGS. 3A and 3B-3E. In the embodiments disclosed herein the exemplary anti-reflective nanostructured surfaces have preferably comprise nanostructures NS with periods that are less than 425 nm, such as for example 3 nm to 400 nm, or 5 nm to 350 nm, or 5 nm to 300 nm. The individual nanostructures width and heights h (or depths h) that are also preferably less than 425 nm, for example 3 nm to 400 nm, or 5 nm to 350 nm, or 5 nm to 300 nm. The individual nanostructures NS may be raised, or indented, and may form ridges, dimples, channels, or holes. The individual nanostructures NS may be, for examples, rectangular, cylindrical or conical and have a cross-sectional dimension w.

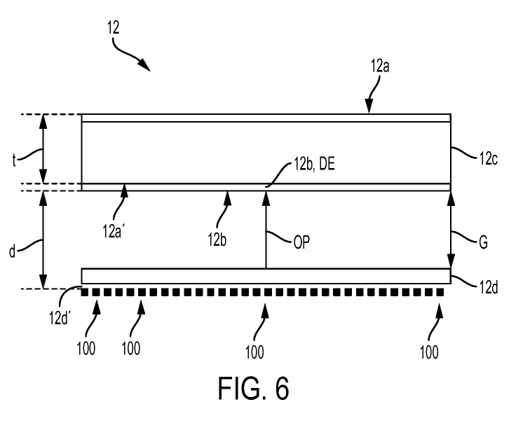

FIG. 3A illustrates schematically one embodiment of a nanostructured anti-reflective (AR) coating surface. This nanostructured anti-reflective coating ARC has a surface relief structure which is periodic in one dimension. In this exemplary embodiment the periodic nanostructures structures NS are “domed” and have a roughly semi-circular cross-section. In other embodiments nanostructured anti-reflective coating ARC (or surfaces ARS) may have triangular, a rectangular, or other cross-sections. These nanostructures NS may be arranged in different patterns, as needed. Additional control over the propagation of incoming light is possible by structuring optical surface in two dimensions, which further reduces unwanted reflections (i.e., reduces stray light). FIGS. 3B-3E illustrate schematically exemplary surface relief structures (comprising a plurality of nanostructures NS) that are periodic in two dimensions. More specifically, FIG. 3E illustrates a nanostructured surface situated on the external surface of an optical component, and an internal diffraction element DE situated under (below) the nanostructured surface. In this embodiment the nanostructured surface is situated over a transparent substrate 12c, such that the diffractive surface DE is sandwiched between the nanostructured surface and the diffractive element. Alternatively, as described below and shown in FIG. 6, the diffractive surface DE may be situated on the opposite side of the substrate 12c, such that the substrate is sandwiched between the diffraction surface and the nanostructured surface.

While stray light improvement in the optical system 10 can be obtained using PVD or CVD based hard anti-reflective coatings, the nano structured coatings ARC described herein have the advantage of being able to be produced in sheet form at low cost using continuous roll-to-roll imprinting processes and can be easily applied to the optical surfaces of the optical components in the optical system 10 of the VR or AR devices. For example, the nano structured anti-reflective coatings ARC described herein and produced in sheet form at low cost using continuous roll-to-roll imprinting processes can be easily applied to the display surface of the display component 12, or any other component with a planar or substantially planar surface. For the lens(es) in the optical system 10 the nanostructured anti-reflective coatings or surface ARC, ARS can be applied by a variety of means. If the lenses or other optical components are made of optical glasses then the nanostructured surfaces (ARS, ARC) can be formed through PVD or CVD processes directly on the surfaces of those components, for example directly on a curved lens surface. The nanostructured anti-reflective surfaces (ARS) can also be etched or even molded into the surface of the glass. One low cost alternative or the lenses is to fabricate the lenses out of moldable optical plastics, and directly form the nanostructured surfaces ARS during the lens molding process itself. Finally, other suitable methods can be utilized to form the nanostructured surfaces described.

In some embodiments the anti-reflective surface or coating comprises a roughened surface portion having an RMS amplitude of at least about 80 nm. For example, in one embodiment the display component 12 has a display surface with a nanostructured anti-reflective surface or coating 12a having a roughened surface portion having an RMS amplitude of at least about 80 nm, for example 80 to 350 nm. In some embodiments the anti-reflective surface or coating ARS, ARC comprise a roughened surface portion having an RMS amplitude of at least about 80 nm, and an unroughened surface portion, wherein the unroughened surface portion forms a fraction of the anti-reflective surface of up to about 0.1, and wherein the roughened surface portion forms a remaining fraction of the anti-reflective or an anti-reflective surface. In some embodiments a lens surface has a nanostructured or anti-reflective surface or coating 14a or 14b having a roughened surface portion having an RMS amplitude of at least about 80 nm, for example 80-350 nm, or 80-300 nm.

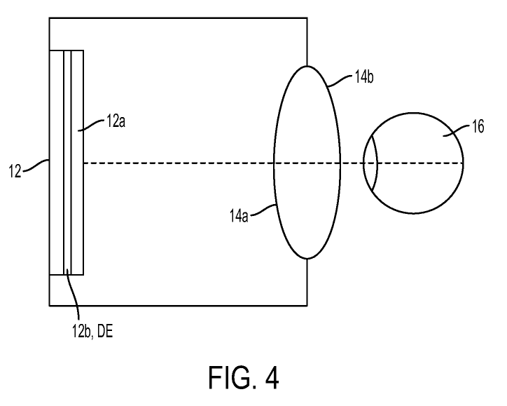

However, nanostructured anti-reflective surfaces can create-sparkle. Sparkle is associated with a very fine grainy appearance of the display, and the pattern of grains may appear to shift with changing viewing angle of the display. Display sparkle may be manifested as bright, dark, and/or colored spots at approximately the pixel-level size scale. Sparkle is described, for example, in US 2012/0300307 entitled “ENGINEERED ANTIGLARE SURFACE TO REDUCE DISPLAY SPARKLE,” filed May 8, 2012 by Nickolas Borreli et al., the contents of which are incorporated by reference herein in their entirety. Sparkle can arise through an interaction between sub-pixels and their associated gaps in pixelated displays and the periodic structure associated with nanostructured anti-reflective surfaces or coatings ARS, ARC. This phenomenon can be minimized or mitigated through the use of a diffraction elements DE, such as diffraction element(s) 12a situated between the pixelated display and the structured coatings or surfaces described above. Sparkle can become an be an issue in a virtual reality (VR), or in an augmented reality (AR) optical systems when nanostructured anti-reflective surfaces are used in conjunction with the display surface of the display component(s) described herein. To mitigate or reduce the problems associated with sparkle, a diffraction element(s) 12b can be placed between the pixelated display 12c and structured anti-reflective coating or surface (ARC, ARS) 12a on the display to reduce sparkle in VR or AR optical systems. This is illustrated schematically, for example, in FIG. 4.

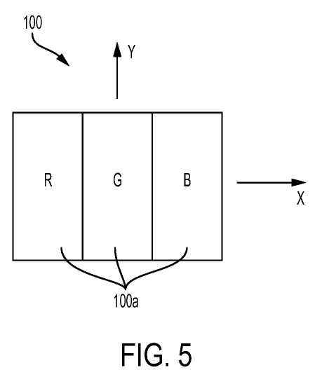

If the display component 12 comprises a pixelated display, such as LCD displays or the like, color images are generally created by using adjacent red (R), green (G), and blue (B) sub-pixels 100a that form pixels 100. In a non-limiting example, FIG. 5 shows a schematic representation of a pixel 100 comprising rectangular red (R), green (G), and blue (B) sub-pixels whose sizes are approximately one third of the size (or pitch) of pixel 100 in the X direction and are equal to the size of pixel 100 in the Y direction. As a consequence of this type of geometry, single color (i.e., red, blue, or green) images constitute sub-pixels with a gap of about ⅔ of the pixel size. This inter-pixel gap is responsible for creating some degree of sparkle in images generated by a plurality of pixels 100. If no inter-pixel gap were present or perceived by a viewer, sparkle would not be observed, regardless of the roughness of the anti-reflective surface. It will be appreciated by those skilled in the art that the present disclosure encompasses pixel and sub-pixel geometries other than that shown in FIG. 5.

More specifically, in some embodiments of the AR and VR devices the display component 12 comprises a transparent substrate 12c that has a roughened or nanostructured anti-reflection surface (or coating) 12a, as described above and a diffraction element DE, 12b, situated below the coating nanostructured anti-reflection (AR) surface coating (12a), as shown for example in FIGS. 3E, 4 and 6. As shown in FIG. 6, in some embodiments the display component 12 comprises a transparent substrate 12c that has a nanostructured anti-reflection surface or coating 12a, as described above and a diffraction element 12b on the opposite surface of or within the transparent substrate 12c. The transparent substrate 12c is situated in front of the pixelated display 12d along the optical path OP. In some embodiments, the substrate 12c comprises a transparent sheet of polymeric material such as, but not limited to, a polycarbonate sheet or the like. In other embodiments, the substrate 12c comprises a transparent glass sheet. The transparent substrate 12c may be a flat sheet or a three dimensional sheet such as, for example, a curved sheet. The diffractive element DE, 12b of the display component 12 is an optical element that modifies light according to the laws of diffraction and may comprise a periodic grating, a quasiperiodic grating, an aperiodic grating, or a random phase pattern that reduces sparkle by filling gaps between sub-pixels 100a in a pixelated display 12d. In some embodiments the grating is a periodic grating with a grating period T and diffraction order k, wherein the periodic grating is separated from a pixel by optical distance D, the pixel emitting light having a wavelength λ, and wherein k·D·λ/Pitch<T<2k·D·λ/Pitch. According to some embodiments the display component 12 of the VR or AR device comprises the transparent substrate 12c and a pixelated display 12d, wherein the transparent substrate 12c comprises the nanostructured anti-reflective surface 12a and a diffraction element DE, for example the diffraction element 12b disposed below the nanostructured anti-reflective surface 12a as shown in FIG. 6. Similar diffractive elements are described in the above mentioned publication US 2012/0300307 entitled “ENGINEERED ANTIGLARE SURFACE TO REDUCE DISPLAY SPARKLE”. According to some embodiments, the transparent substrate with an anti-reflective surface and a diffractive element situated below the anti-reflective surface, when disposed in front of a pixelated display 12d, at least partially reduces inter-inter-pixel gaps in the pixelated display. According to some embodiments the display component 12 comprises: a pixelated display 12d comprising a plurality of pixels 100, each of the plurality of pixels 100 having a pixel size; a transparent substrate 12c disposed in front of and substantially parallel to the pixelated display 12d, the transparent substrate 12c having a nanostructured anti-reflective surface 12a distal from the pixelated display 12d; and a diffraction element 12b disposed between the nanostructured anti-reflective surface 12a and the pixels 100 of the pixelated display 12d.

According to some embodiments, transparent substrate 12c has a thickness t, an nanostructured anti-reflective surface 12a, and a diffraction element 12b disposed below the nanostructured anti-reflection surface 12a (e.g., between the nanostructured surface 12a and the pixelated display 12d). In the embodiment shown in FIG. 6, diffraction element 12b is disposed on a second surface 12a′ of the substrate 12c, opposite nanostructured anti-reflective surface 12a. In some embodiments, diffraction element 12b is disposed in a polymeric film or epoxy layer, which is disposed on second surface 12a′ of the transparent substrate. In other embodiments, the diffraction element 12b is disposed in the bulk of transparent substrate 12c and between nanostructured anti-reflective surface 12a and second surface 12a′. Pixelated display 12d may be a LCD display, an OLED display, or the like that are known in the art, and comprises a plurality of pixels 100. Pixelated display 12d is separated from transparent substrate 12c (or from the diffraction element(s) 12b, if present) by gap G, and plurality of pixels 100 are separated from diffraction element(s) 12b by optical distance d.

In some embodiments, nanostructured anti-reflective surface 12a comprises a coated or structured polymeric film (often a polarizing film) which is directly laminated to the surface of the transparent substrate 12c. In other embodiments, nanostructured anti-reflective surface 12a may be formed by chemically etching a surface of the transparent substrate 12c, either directly or through an acid- or alkali-resistant mask.

When transparent substrate 12c is placed in front of a pixelated display 12d, diffraction element 12b is located along optical path OP and is located between nanostructured anti-reflective surface 12a and pixelated display 12d such that, when viewed through diffraction element 12b (and nanostructured anti-reflective surface 12a), the gap between pixels in an image generated by pixelated display 12d is reduced. In one embodiment, the gap between pixels in an image generated by pixelated display 12d is reduced to less than about one third the length (or width) of the individual pixels. In some embodiments, the gap between pixels is not visible to the unaided human eye.

Diffraction element 12b may be applied to second surface 12a′ of substrate 12c as a polymeric film. Alternatively, diffraction element 12b may be formed on—and integral to—second surface 12a′.

In some embodiments, the gap G between the pixelated display 12d and the substrate 12c or the diffractive element DE is filled with epoxy (not shown), so as to contact second surface 12a′ and adhere or bond transparent substrate 12c to pixelated display 12d. The epoxy preferably has a refractive index that partially matches that of transparent substrate 12c in order to eliminate Fresnel reflections on second surface 12a′ and front face 12d′ of pixelated display 12d. The epoxy preferably has a refractive index that differs from that of diffractive element 12b and an index contrast that is sufficiently low to attenuate the Fresnel reflection. At the same time, the index contrast of the epoxy is large enough to keep the roughness amplitude of the diffraction element at reasonable levels. With an index contrast of 0.05, for example, the amplitude of the Fresnel reflection is around 0.04% and the ideal grating amplitudes are 4.8 μm and 3.4 μm for sinusoidal and square gratings, respectively. Given relatively large periods on the order of 20 μm to 40 μm, such amplitudes are achievable for grating manufacturing processes such as microlithography, embossing, replication, or the like.

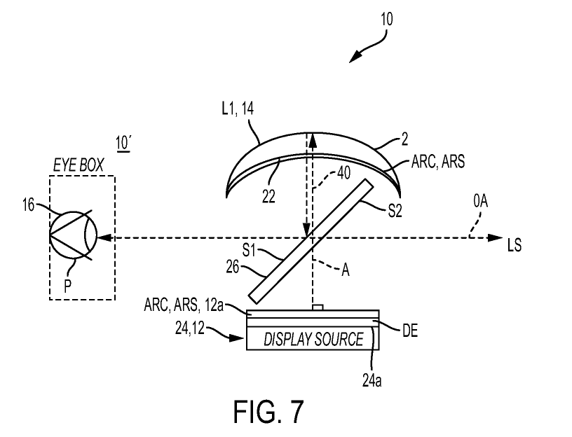

FIG. 7 illustrates one embodiment of an optical system 10 of an augmented reality device. According to an aspect of the present disclosure, augmented reality system comprises:
a) a display source 24, for example a display component 12 that generates an image-bearing light from a display surface (e.g., a flat display surface 24a);
b) at least one lens L1, spaced apart from the display source and having an a incident refractive 22 surface concave to the display source and having a reflective surface 20, for example concave to the display source, wherein a principal axis of the reflective surface 20 is normal or perpendicular to the display source 24; and
c) a beam splitter plate 26 disposed in free space between the display source 24 (e.g., a display component 12) and the lens L1, the beam splitter having first and second parallel surfaces that are oblique to a line of sight of a viewer.
   In this embodiment at least one of the surfaces of the optical components 12, L1, 26 include one or more structured (nano-structured) surfaces or coatings ARS, ARC described above (see, for example, FIGS. 3A-3F). The display component 12 (or the display source 24) may have a pixelated display. Thus, according to some embodiments, a diffractive element DE, for example diffractive element(s) 12b described above, may be utilized in display components 2 of the augmented reality (AR) devices in order to reduce sparkle. In some embodiments, lens L1 may a lens 14, or may comprise more than one lens components. According to some embodiments the an augmented reality device comprises two lens components. According to some embodiments the an augmented reality device comprises at list one lens component an a mirror or a reflective surface. In some embodiments the lens component is air spaced from the mirror or a reflective surface. For example, the lens L1 of FIG. 7 may be split into two or more optical components, with at least refractive component with optical power (e.g., lens 14) facing the display component 12, and the mirror situated behind the refractive component such that the lens 14 is situated between the mirror and the display component.

A structured anti-reflective) coatings or surface ARC, ARS may be present on surface 22 of the lens element, or on the surface S1 or S2 of the beam splitter 26, or on surface 24a of the display source 24. According to some embodiments a diffraction element(s) is DE is situated between the display surface 24a and nanostructured anti-reflective coating ARC situated over the display surface 24a to reduce sparkle.

Thus, according to an aspect of the present disclosure, augmented reality device comprises:

(a) a display component 12,24 that generates an image-bearing light from a display surface (e.g., a flat display surface 24a);

(b) a lens L1, 14 spaced apart from the display source and having an aspheric incident refractive surface concave to the display source and having an aspheric reflective surface concave to the display source, wherein a principal axis of the reflective surface is normal to the display surface; and

(c) a beam splitter plate 26 disposed in free space between the display source and the lens and having first and second parallel surfaces that are oblique to a line of sight of a viewer,

wherein the lens L1, 14 and the beam splitter plate 26 define a viewer eye box for the image-bearing light along the line of sight of the viewer. In some embodiments at least one of the surfaces of the optical components includes a nano-structured anti-reflective coating or surface ARC, ARS as described above.

According to some embodiments a structured anti-reflective coatings or surface may be present on at least one surface of the lens element L1 (e.g., surface 22), and/or on the surface S1 or S2 of the beam splitter. In addition, and structured anti-reflective coating situated may be situated over the display surface 24a and a diffraction element DE can be placed between the display surface 24a, and structured anti-reflective coating situated over the display surface 24a to reduce sparkle.

According to some embodiment the display component 12 of an AR or VR device comprises a transparent substrate that comprises an anti-reflective surface and a diffraction element DE disposed below the anti-reflective surface, such that the transparent substrate, when disposed in front of the pixelated display, at least partially reduces inter-pixel gaps in the pixelated display.

According to some embodiments, the diffraction element DE is disposed on a second surface of the transparent substrate, the second surface being opposite the anti-reflective surface. According to some embodiments, the diffraction element DE is integral to the second surface of the transparent substrate. According to some embodiments, the diffraction element DE has a first refractive index and the second surface of the transparent substrate is in contact with an epoxy layer having a second refractive index that is different from the first refractive index. According to some embodiments the transparent substrate 12c has a second surface 12a′ opposite the anti-reflective surface ARS, 12a and a bulk portion between the anti-reflective surface and the second surface 12a′, and the diffraction element DE is disposed in the bulk portion. According to some embodiments, the diffraction element DE is a periodic grating having a grating period that is about one third of the pixel size. According to some embodiments, the diffraction element DE is a periodic grating having a grating period that is about one quarter to one half of the pixel size (or width). In some embodiments the pixel width is about 0.015 mm to 0.05 mm, for example 0.015 mm to 0.025 mm. In some embodiments the pixel width is about 0.04 mm to 0.05 mm, for example 0.044 mm. According to some embodiments, the diffraction element DE comprises one of a periodic grating, a quasiperiodic grating, an aperiodic grating, or a random phase pattern disposed on the second surface. According to some embodiments, the diffraction element DE is disposed on a polymeric film which is disposed on the second surface.

According to some embodiments the t transparent substrate comprises a sheet of polymeric material or a glass sheet (e.g., comprises one of a soda lime glass, an alkali aluminosilicate glass, and an alkali aluminoborosilicate glass.). According to some embodiments, the transparent substrate comprises strengthened glass. The strengthened glass may be strengthened by ion exchange, such that the transparent substrate has at least one surface having a region under a compressive stress, the region extending from the surface to a depth of layer within the transparent substrate. The strengthened glass may have a region with compressive stress of at least about 350 MPa and the depth of the compressive region of at least 15 μm. The strengthened glass may be, for example, for example Corning® Gorilla® glass, available from Corning Incorporated of Corning N.Y.

While typical embodiments have been set forth for the purpose of illustration, the foregoing description should not be deemed to be a limitation on the scope of the disclosure or appended claims. Accordingly, various modifications, adaptations, and alternatives may occur to one skilled in the art without departing from the spirit and scope of the present disclosure

It will be apparent to those skilled in the art that various modifications and variations can be made without departing from the spirit or scope of the invention. Since modifications combinations, sub-combinations and variations of the disclosed embodiments incorporating the spirit and substance of the invention may occur to persons skilled in the art, the invention should be construed to include everything within the scope of the appended claims and their equivalents.

What is claimed is:

1. A virtual or an augmented reality device comprising:
(i) a display component comprising a display surface,
(ii) a lens air spaced from the display component;
wherein at least one of said display component or said lens comprises a stray light reducing structured surface.

2. The device of claim 1 wherein embodiments the stray light reducing structured surface comprises a plurality of nanostructures.

3. The device of claim 2, wherein each of the plurality of nanostructures have a width greater than 1 nm and less than 1 micron.

4. The device of claim 1, wherein said device further comprises a plurality of stray light reducing structured surface, each comprising a plurality of nanostructures.

5. The device of claim 1 wherein the lens is directly in front of the display component.

6. The device of claim 5 wherein the lens includes a curved refractive surface and a curved reflective surface.

7. The device of claim 6, wherein a beam splitter is situated between the lens and the display component.

8. The device of claim 1 wherein the stray light reducing structured surface comprises a coating.

9. The device of claim 1 wherein the stray light reducing structured surface comprises a structured anti-reflective coating.

10. The device of claim 1 wherein the display component comprises the stray light reducing structured surface, the display component further comprising a diffraction element situated between the display surface and the stray light reducing structured surface.

11. The device of claim 10 wherein the stray light reducing structured surface comprises a structured anti-reflective coating.

12. The device of claim 1, wherein said display component further comprises a transparent substrate comprising an anti-reflective surface and a diffraction element disposed below the anti-reflective surface, wherein the transparent substrate, when disposed in front of a pixelated display of the display surface at least partially reduces inter-pixel gaps in the pixelated display.

13. The device of claim 12, wherein the diffraction element is disposed on a second surface of the substrate, the second surface being opposite the anti-reflective surface.

14. The device of claim 12, wherein the diffraction element is integral to the second surface.

15. The device of claim 12, wherein the diffraction element comprises one of a periodic grating, a quasiperiodic grating, an aperiodic grating, and a random phase pattern disposed on the second surface.

16. The device of claim 12, wherein the transparent substrate has a second surface opposite the anti-reflective surface and a bulk portion between the anti-reflective surface and the second surface, and wherein the diffraction element is disposed in the bulk portion.

17. An augmented reality device comprising:
a display component comprising a display surface,
at least one lens comprising a concave refractive surface, said at least one lens being air spaced from the display component;
wherein at least one of said display component or said lens comprises a stray light reducing structured surface.

18. The augmented reality device of claim 17, wherein the stray light reducing structured surface comprises a coating.

19. The augmented reality device of claim 17, wherein the stray light reducing structured surface comprises a structured anti-reflective coating.

20. The augmented reality device of claim 17, wherein the stray light reducing structured surface comprises an anti-reflective coating with a plurality of nanostructures.

21. The augmented reality device of claim 14, further comprising a diffraction element situated between the display surface and the structured anti-reflective coating.

22. The augmented reality device of claim 17, wherein:
the at least one lens is spaced apart from the display component and has an a incident refractive surface concave to the display surface and having a reflective surface concave to the display surface, wherein a principal axis of the reflective surface is normal to the display surface; and
a beam splitter plate disposed in free space between the display surface and
the lens and having first and second parallel surfaces that are oblique to a line of sight of a viewer.

23. The augmented reality device of claim 17, wherein the lens and the display component are not perpendicular to a line of sight of a viewer.
